(19) United States
(12) Patent Application Publication
(10) Pub. No.: US 2026/0080851 A1
(43) Pub. Date: Mar. 19, 2026

(54) Generation of Context-Based Audio Content

(71) Applicant: Google LLC, Mountain View, CA (US)

(72) Inventors: Vishu Goyal, Mountain View, CA (US); Rosemond Gerold Dorleans, San Francisco, CA (US)

(21) Appl. No.: 18/885,101

(22) Filed: Sep. 13, 2024

(51) Int. Cl. G10H 1/00; G06F 40/40

(52) U.S. Cl. CPC G10H 1/0025; G06F 40/40; G10H 2210/111; G10H 2210/391

(57) ABSTRACT

Methods, systems, devices, and non-transitory computer readable media for generating context-based audio content are provided. The disclosed technology can include receiving content data comprising content associated with one or more data multimodalities. One or more prompts associated with the content can be received. One or more contexts associated with the content data can be determined. Based on inputting the content data, the one or more prompts, and context data based on the one or more contexts into one or more machine-learned models, one or more context-based audio segments based on the content data can be generated. The one or more machine-learned models can be configured to generate the one or more context-based audio segments based on recognition of one or more features of the content data and the context data. Furthermore, context-based audio content based on the one or more context-based audio segments can be generated.

### FIELD

The present disclosure relates generally to generating context-based audio content based on content that can be associated with various data modalities. More particularly, the present disclosure relates to the use of machine-learned models to generate context-based audio content based on the detection, recognition, or classification of features in content that can comprise multimodal data comprising images, text, audio, or video.

### BACKGROUND

Social media can be associated with a wide variety of content including musical content that can come from a variety of sources including online data sources and locally stored data. For example, a user may acquire music from online sources such as streaming services or the user’s locally stored music collection. Further, user’s may purchase music from online music stores. The music can be used in many ways including being associated with other types of content. For example, music can be used as a ring tone or alarm clock. Additionally, music can be distributed to other users in a variety of ways such as through websites that stream music and music videos. However, the process of sorting through music and sharing information about musical preferences can be time consuming. Further, adding music to other types of content can be similarly time consuming and complex. Accordingly, there may be different approaches to working with music associated with social media content.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of generating context-based audio content. The computer-implemented method can comprise receiving, by a computing system comprising one or more processors, content data comprising content associated with one or more data multimodalities. The computer-implemented method can comprise determining, by the computing system, one or more contexts associated with the content data. The computer-implemented method can comprise determining, by the computing system, based on inputting the content data, the one or more prompts, and context data based on the one or more contexts into one or more machine-learned models, one or more context-based audio segments associated with the content data. The one or more machine-learned models can be configured to determine the one or more context-based audio segments based on recognition of one or more features of the content data and the context data. Furthermore, the computer-implemented method can comprise generating, by the computing system, context-based audio content based on the one or more context-based audio segments.

Another example aspect of the present disclosure is directed to one or more tangible non-transitory computer-readable media storing computer-readable instructions that when executed by one or more processors cause the one or more processors to perform operations. The operations can comprise receiving content data comprising content associated with one or more data multimodalities. The operations can comprise determining one or more contexts associated with the content data. The operations can comprise determining, based on inputting the content data, the one or more prompts, and context data based on the one or more contexts into one or more machine-learned models, one or more context-based audio segments associated with the content data. The one or more machine-learned models can be configured to determine the one or more context-based audio segments based on recognition of one or more features of the content data and the context data. Furthermore, the operations can comprise generating context-based audio content based on the one or more context-based audio segments.

Another example aspect of the present disclosure is directed to a computing system comprising: one or more processors; one or more non-transitory computer-readable media storing instructions that when executed by the one or more processors cause the one or more processors to perform operations. The operations can comprise receiving content data comprising content associated with one or more data multimodalities. The operations can comprise determining one or more contexts associated with the content data. The operations can comprise determining, based on inputting the content data, the one or more prompts, and context data based on the one or more contexts into one or more machine-learned models, one or more context-based audio segments associated with the content data. The one or more machine-learned models can be configured to determine the one or more context-based audio segments based on recognition of one or more features of the content data and the context data. Furthermore, the operations can comprise generating context-based audio content based on the one or more context-based audio segments.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that can generate context-based audio content according to example embodiments of the present disclosure;

FIG. 1B depicts a block diagram of an example computing device that can generate context-based audio content according to example embodiments of the present disclosure;

FIG. 1C depicts a block diagram of an example computing device that can generate context-based audio content according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts an example of selecting context-based audio content according to example embodiments of the present disclosure;

FIG. 5 depicts an example of generating context-based audio content according to example embodiments of the present disclosure;

FIG. 6 depicts an example of generating context-based audio content according to example embodiments of the present disclosure;

FIG. 7 depicts an example of a link note based on context-based audio content according to example embodiments of the present disclosure;

FIG. 8 depicts a flow chart diagram of an example method of generating context-based audio content according to example embodiments of the present disclosure;

FIG. 9 depicts a flow chart diagram of an example method of generating context-based audio segments according to example embodiments of the present disclosure; and

FIG. 10 depicts a flow chart diagram of an example method of training machine-learned models to generate context-based audio segments according to example embodiments of the present disclosure.

Reference numerals that are repeated across plural figures are intended to identify the same features in various implementations.

### DETAILED DESCRIPTION

In general, the present disclosure is directed to generating context-based audio content based on the detection, recognition, and/or classification of features (e.g., visual features and/or textual features) in content data associated with one or more data modalities (e.g., multimodal data comprising images, audio, text, and/or video). Further, the context-based audio content can be automatically generated based on content and one or more contexts associated with the content and including location information, temporal information, event information, application information (e.g., web browser information comprising a search history including recent visited web pages), and/or information associated with a user. In particular, the disclosed technology can generate context-based audio content associated with a particular context and/or prompt (e.g., a user provided prompt) associated with the content. In some embodiments, he disclosed technology can be configured to select context-based audio segments from an existing repository of candidate audio segments (e.g., songs from a user’s music collection). Further, the disclosed technology can implement machine-learned models (e.g., generative machine-learned models that can comprise transformer models and/or diffusion models) that have been configured and/or trained to generate or select context-based audio content based on the detection, classification, and/or recognition of features of content, context, and/or a prompt. Additionally, the context-based audio content can be included in a link note that can be shared with other users and/or associated with a web resource (e.g., a social media post or a search result).

For example, a computing system can receive content data that can comprise content associated with one or more data modalities. In particular, the content can comprise images, audio segments, and/or video segments. For example, the content can comprise an image of a cabana surrounded by palm trees and located near a sandy beach. Further, the content can be based on an image obtained from a website specializing in tropical vacations. The computing system can then determine one or more contexts associated with the content data. For example, the content data comprising the image of the cabana may comprise metadata indicating that the image is from the travel website and/or indicating the geographic location (e.g., Hawaii) shown in the image. Further, the content data may be associated with a particular user (e.g., the content was retrieved by a particular user that the computing system is able to identify). The information associated with the user may comprise an indication of the user’s preferences based on previous locations to which the user has travelled or posted comments about on social media platforms. In some embodiments, prompt data associated with one or more prompts can be received by the computing system. The prompt data can be associated with the content data and/or indicate a type of audio segment (e.g., musical genre) that is preferred.

The content data including the image of the cabana, the context data based on the one or more contexts that were determined, and/or the prompt data can be inputted into a machine-learned model, that can generate one or more context-based audio segments. The one or more machine-learned models can be configured and/or trained to generate the context-based audio segments based on the detection, recognition, and/or classification of features of the content data, the prompt data, and/or the context data. For example, the one or more machine-learned models can be configured and/or trained to detect and/or recognize visual features in images (e.g., recognize faces and/or objects in images), parse text in the prompt data, and/or determine relationships between the content data, context data, and/or prompt data. Further, the one or more machine-learned models can comprise a generative model that is configured and/or trained to generate the context-based audio segments and/or select the context-based audio segments from candidate audio segments.

The disclosed technology can then generate context-based audio content based on the context-based audio segments. For example, content comprising an image of a tropical beachside cabana can include context-based audio content that includes Hawaiian style instrumental music that is relevant and/or appropriate to the image including the cabana. Further, the disclosed technology can generate a link note based on the context-based audio content. The link note can include the context-based audio content and a link to a web resource (e.g., a web page or social media post). For example, the link note can comprise the image of the cabana, the context-based audio segment, and a link to the web page from which the image was retrieved. Further, the link note can be shared with other users and/or included in a web resource. For example, the link note can be sent to one or more users in a user group of contacts associated with the user that generated the link note.

The context-based audio content can be used in a variety of applications including social media applications. The ability to quickly and easily generate context-based audio content can allow for more effective distribution of various types of content that can be used in a variety of applications. As such, the disclosed technology allows for improved generation of context-based audio content that may be used in a variety of applications including social media applications, texting applications, email applications, online forum applications, and/or various types of other communication applications.

Accordingly, the disclosed technology can automatically generate context-based audio content that is relevant to content data associated with various data modalities. Further, the disclosed technology can assist a user in more effectively performing the technical task of generating context-based audio content by means of a continued and/or guided human-machine interaction process in which content comprising multimodal data (e.g., images, video segments, and/or text segments) is received and context-based audio content is generated in real-time based on continuously updated content information, prompt information, and/or context information. For example, a user can use a computing device (e.g., a smartphone) to capture an image. The computing device can determine a context associated with the image (e.g., the time at which the image was captured) and send the image and the context data to a remote machine-learned model system that generates context-based audio content based on the image. The remote machine-learned model can then send the context-based audio content back to the computing device which can be used to generate a link note based on the context-based audio content.

The disclosed technology can be implemented in a computing system (e.g., an audio generation computing system) that is configured to access data and/or perform operations on the data. For example, the operations performed by the computing system can comprise receiving content data associated with one or more data modalities, receiving prompt data comprising one or more prompts, determining contexts associated with the content data, generating, based on inputting the content data, prompt data, and/or context data based on the one or more contexts into a machine-learned model, one or more context-based audio segments associated with the content data, and/or generating context-based audio content based on the one or more context-based audio segments. Further, the computing system can leverage one or more machine-learned models that have been configured and/or trained to process (e.g., detect, recognize, and/or classify) content data, prompt data, and/or context data and generate one or more context-based audio segments based on features in the content data, prompt data, and/or context data.

The computing system can be included as part of a system that includes a server computing device that receives data (e.g., content data comprising images, audio segments, and/or video segments) from a user’s client computing device, performs operations based on the data and sends output comprising context-based audio segment data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with the detection, recognition, and/or classification of content data comprising images, audio, and/or video; the generation of context-based audio segments based on content data, prompt data, and/or context data, and/or the generation of context-based audio content based on the context-based audio segments.

The computing system can receive, access, and/or retrieve content data. The content data can comprise content. The content can be associated with one or more data modalities. For example, the content data can comprise one or more images, one or more text segments, one or more audio segments, one or more video segments. For example, the content data can comprise text segments or images copied from a website, one or more images or video segments captured by a computing device (e.g., smartphone) of a user, or content retrieved via an application (e.g., a social media application). The content data can comprise information (e.g., metadata) that can be used to determine context associated with the content data. For example, the content data can comprise location data that can indicate geographic coordinates at which content data was generated and/or modified (e.g., the location an image was captured and/or a video segment was recorded). In some embodiments, the computing system can be configured to deduplicate the content data that is received. For example, if one or more copies of the same content (e.g., the same image, text segment, audio segment, and/or video segment) are received, the computing system can remove the duplicate copies of the content.

The computing system can receive, access, and/or retrieve prompt data. The prompt data can comprise one or more prompts. For example, the computing system can generate prompt data based on one or more prompts input by a user into the computing system via one or more input devices (e.g., a keyboard and/or a microphone). The one or more prompts can be associated with the content data. Further, the one or more prompts can comprise one or more indications (e.g., text-based instructions and/or spoken instructions) from a user. For example, the prompt data can indicate a preferred genre of music, a theme (e.g., a seasonal theme or holiday theme), a tempo for the context-based audio segments, and/or a user associated with the context-based audio segments (e.g., an intended recipient of the context-based audio content). The one or more prompts can be entered via an input device (e.g., keyboard and/or microphone). For example, if the content data comprises an image of a baseball diamond, the prompt might indicate “GENERATE SOME BASEBALL MUSIC.”

In some embodiments, the one or more prompts can comprise one or more links (e.g., hyperlinks) to content. For example, the one or more prompts can comprise a link to a webpage associated with baseball. The computing system can follow the link to the web page and process the page to determine content that is associated with the page. For example, the link can be associated with an image or a text segment that can be used as a prompt. In some embodiments, the link can comprise a portion of the content and can be included together with an additional prompt text-based prompt provided by a user. In some embodiments, the one or more prompts can be based on one or more search results and/or one or more search queries. For example, a search query (e.g., fun facts about baseball) can be included with content comprising an image of a baseball bat and/or baseball catcher’s mitt.

The computing system can determine one or more contexts. The one or more contexts can be associated with the content data and/or the prompt data. The computing system can determine the one or more contexts based on searching and/or processing data comprising location data, temporal data, event data, application data, search data, and/or information associated with a user. For example, the computing system can process metadata that is included in the content data and comprises indications of where the content data was generated and/or modified, one or more entities that generated and/or modified the content data (e.g., a user that generated and/or modified the content data), one or more times that the content data was generated or modified, a search history and/or search queries associated with the content data, and/or an application that accessed, generated, and/or modified the content data. Context data can be generated and/or determined based on the one or more contexts. The context data can comprise information and/or data associated with the one or more contexts. For example, the computing system can access the one or more contexts and/or information (or data) associated with the one or more contexts, and generate and/or determine context data based on the one or more contexts. Further, the context data can be based on and/or comprise one or more contexts comprising one or more web browsing histories, one or more purchase histories, user profile data (e.g., profile data indicating the web services a user is associated with), and/or a link note history (e.g., a history of one or more link notes that a user generated, modified, sent, received, and/or viewed).

The computing system can generate and/or determine one or more context-based audio segments. The one or more context-based audio segments can be based on data comprising the content data, the context data, and/or the prompt data (e.g., one or more prompts included in the prompt data). The one or more machine-learned models can be configured and/or trained to detect, recognize, and/or classify one or more features of the content data, the context data, and/or the prompt data. Further, the one or more machine-learned models can be configured and/or trained to generate and/or determine one or more context-based audio segments based on input comprising the content data, the context data, and/or the prompt data. The one or more context-based audio segments can comprise one or more musical segments, one or more sound effects, one or more electronic sounds (e.g., electronic beeps), animal sounds (e.g., cats purring, dogs barking, whale song, and/or birdsong), mechanical sounds (e.g., hammering, machinery, and/or vehicular sounds), and/or one or more conversation segments.

In some embodiments, the computing system can select the one or more context-based audio segments from a plurality of candidate audio segments. For example, the computing system can access data comprising a plurality of candidate audio segments (e.g., a song repository of a user associated with the content). Further, the one or more machine-learned models can be configured and/or trained to determine the one or more features of the content, context, and/or prompts and select one or more candidate audio segment from the plurality of candidate audio segments based on the similarity of the one or more features of the candidate audio segment to the determined one or more features based on the content data, the context data, and/or the prompt data.

In some embodiments, the computing system can generate the one or more context-based audio segments based on recognition of the one or more features of content data, prompt data, and/or context data. The one or more machine-learned models can comprise one or more generative models that are configured and/or trained to generate the one or more context-based audio segments. In some embodiments, the computing system can implement one or more machine-learned models comprising an audio diffusion model that is configured to generate one or more context-based audio segments based on input comprising the content, the context data, and/or the prompt data. The one or more machine-learned models can generate the one or more context-based audio segments based on input comprising the content, the context data, and/or the prompt data. For example, the computing system can generate one or more context-based audio segments that have audio features (e.g., the inclusion of absence of certain musical instruments, the tempo of the music, the inclusion or absence of vocals, and/or musical genre) that match or are similar to the audio features associated with the content data, content data, and/or prompt data. In some embodiments, a tempo of the one or more audio segments can be based on the content data, the prompt data, and/or the context data. For example, context data can comprise information associated with a user’s listening preferences which can indicate a preference for lower tempo music and the context-based audio segments can have a lower tempo based on the user’s listening preferences.

In some embodiments, the computing system can generate one or more context-based audio segments based on content comprising one or more audio segments. The computing system can generate one or more context-based audio segments that can accompany the one or more audio segments. Further, the computing system can generate and/or determine one or more context-based audio segments comprising one or more instruments and/or a tempo that can be in harmony with the one or more audio segments. For example, the computing system can generate one or more context-based audio segments comprising instrumental music (e.g., piano music, violin music, drum music, and/or trumpet music) that can accompany one or more audio segments comprising vocal audio (e.g., a vocalist singing).

In some embodiments, a computing system can determine one or more contexts based on information associated with one or more locations. For example, information associated with the one or more locations can be based on location data associated with one or more locations (e.g., latitude, longitude, and/or altitude) at which content data was generated and/or modified. The location data can be included in the content data (e.g., metadata), in an application that generated the content data (e.g., a social media application that generated content data comprising text content).

Further, the one or more machine-learned models can be configured and/or trained to generate the one or more context-based audio segments based on the information associated with the one or more locations. For example, the one or more machine-learned models can generate and/or determine the one or more context-based audio segments based on audio characteristics that can be associated with the location. For example, if the context indicates that a location is a rowing course and the content comprises an image of a crew rowing an eight on the water, the one or more context-based audio segments generated by the one or more machine-learned models can comprise sound effects associated with rowing (e.g., coxswain calls or the sound of oars being released from the water) and/or music that is determined to be relevant and/or appropriate to the content and/or location associated with the content.

In some embodiments, the computing system can determine the one or more contexts based on one or more temporal indications that can be associated with one or more times at which the content data was generated or modified. For example, information associated with the one or more temporal indications can comprise time stamps that indicate one or more times at which the content data was generated and/or modified. The one or more temporal indications can be included in the content data, in an application that generated the content data (e.g., a web browser that indicates the time at which content data comprising an image or text segment was downloaded).

Further, the one or more machine-learned models can be configured and/or trained to determine the one or more context-based audio segments based on the one or more temporal indications. For example, the one or more machine-learned models can be configured and/or trained to determine that an image was captured during a particular time of year and can generate one or more context-based audio segments that refer to the time of year. For example, if the context indicates that content was generated during the winter and the content comprises an image of a person cross-country skiing, the one or more context-based audio segments can comprise music with a winter theme (e.g., winter lyrics).

In some embodiments, the computing system can determine the one or more contexts based on information associated with one or more events that can be associated with the content data. For example, information associated with the one or more events can comprise identifiers (e.g., the name of an event) and/or classes (e.g., holiday) associated with one or more events. Further, the one or more machine-learned models can be configured and/or trained to generate the one or more context-based audio segments based on the one or more events. For example, if the context indicates that content was generated during Thanksgiving and the content comprises an image of autumn leaves or a pumpkin, the one or more context-based audio segments can comprise festive music suitable for a Thanksgiving celebration.

In some embodiments, the computing system can determine the one or more contexts based on information associated with one or more applications that can be associated with the content data. For example, the information associated with the one or more applications can comprise web browser data that indicates the times at which content data was downloaded or viewed, text message application data that can include the content of text messages (e.g., text, images, audio, and/or video content), email application data that can comprise the content of email messages, and/or social media application data that indicates social media postings that can be associated with the content data. The one or more machine-learned models can be configured and/or trained to generate and/or determine the one or more context-based audio segments based on input comprising the one or more applications. Further, the one or more machine-learned models can be configured and/or trained to detect, recognize, and/or classify the information associated with the one or more applications and generate the one or more context-based audio segments based on the information associated with the one or more applications. For example, if the context indicates that content was generated by a photo viewing application that indicates the activities people in a video are engaging in, the one or more context-based audio segments can comprise sound effects that are relevant to the activities (e.g., the sound of sawing wood and hammering if the content comprises an image of people near a construction site).

In some embodiments, the computing system can determine the one or more contexts based on one or more search queries and/or search results that can be associated with the content data. For example, the information associated with the one or more search queries can comprise web browser data that indicates search queries associated with a user and/or a search history associated with a user. The one or more machine-learned models can be configured and/or trained to recognize and/or classify the one or more search queries and/or search history and generate the one or more context-based audio segments based on the one or more search queries. For example, if the context is based on a search history that indicates a user’s interest in piano music and the composer Frederic Chopin, content comprising an image of a piano can result in one or more context-based audio segments comprising piano music composed by Frederic Chopin.

In some embodiments, the computing system can determine the one or more contexts based on information associated with one or more users that can be associated with the content data. For example, the information can be based on data associated with a user logged into an application (e.g., a social media application), a user providing their name as part of the prompt data, and/or an online account (e.g., an account for a web service). Further, the one or more machine-learned models can be configured and/or trained to generate the one or more context-based audio segments based on the information associated with the one or more users. For example, if the context comprises a user’s occupation, the one or more context-based audio segments can comprise music that references the user’s occupation (e.g., a song about long-haul trucking for a user that is a truck driver).

The one or more machine-learned models can comprise one or more multimodal generative models (e.g., one or more multimodal transformer models) that are trained to generate the one or more context-based audio segments based on input comprising training data. The training data can comprise training content data and/or training context data. The training content data can comprise a plurality of training images, a plurality of training audio segments, a plurality of training video segments, a plurality of training prompts, and/or a corresponding plurality of ground-truth audio segments. Further, the training context data can comprise a plurality of training locations, a plurality of training temporal indications, a plurality of training applications, a plurality of training identified users, a plurality of training search results, and/or a plurality of training search queries.

In some embodiments, the training data can comprise a plurality of embeddings. The plurality of embeddings can comprise a lower-dimensional vector space representation of the training data. For example, training images can be represented in a lower-dimensional vector space that can preserve key features of the images in a smaller dimensional vector space than the higher-dimensional vector space of the original image (e.g., a high-dimensional vector space that can include RGB values for the millions of pixels in an image). The plurality of embeddings can be arranged such that semantically similar content is closer together in the vector space. The plurality of embeddings can be generated based on the training content data and/or training context data. For example, the plurality of embeddings can be generated based on inputting the training data into one or more machine-learned models configured and/or trained to generate the plurality of embeddings.

The one or more machine-learned models can be trained to generate and/or determine one or more audio preferences of a user based on training data comprising a plurality of training audio segments of a user associated with the content data. Further, the one or more machine-learned models can be configured to determine the one or more context-based audio segments based on the one or more audio preferences. For example, the one or more machine-learned models can determine that a user prefers higher tempo music, prefers piano music to trumpet music, and prefers Baroque period music to rock music. The training data can be used after receiving the express consent of the user and after notifying the user that the training data can be used to train one or more machine-learning models.

The one or more machine-learned models can be configured and/or trained to perform one or more object processing (e.g., object detection operations) to detect, recognize, and/or classify one or more objects in the content data (e.g., content data comprising one or more images and/or one or more video segments). The one or more machine-learned models can be configured and/or trained to generate the one or more context-based audio segments based on the detection, recognition, and/or classification of one or more objects in the content data. For example, the one or more machine-learned models can detect one or more animals, vehicles, buildings, musical instruments, sports equipment, faces, roads, trees, and/or natural geographic features in content data. In some embodiments, the one or more machine-learned models can be configured to recognize one or more objects in the content data and generate and/or determine the one or more context-based audio segments based on the recognition of the one or more objects. For example, the one or more machine-learned models can recognize a piano in an image and can generate and/or determine context-based audio segments comprising piano music and/or cello music.

The one or more machine-learned models can be configured and/or trained to perform one or more audio processing operations to detect, recognize, and/or classify one or more audio features of the content data (e.g., content data comprising audio segments associated with music and/or speech). The one or more machine-learned models can be configured and/or trained to generate and/or determine the one or more context-based audio segments based on the detection, recognition, and/or classification of one or more audio features of the content data. For example, the one or more machine-learned models can generate and/or determine one or more context-based audio segments comprising music (e.g., piano music) based on the detection, recognition, and/or classification of a voice in input comprising content data comprising an audio segment of a singer singing a song a cappella.

The computing system can generate context-based audio content. The context-based audio content can be based on the one or more context-based audio segments. For example, the context-based audio content can comprise an image (e.g., an image or video segment from the content data) and/or a context-based audio segment (e.g., music that is relevant to the content data). Further, the context-based audio content can be generated in a format based on a type of application that will use the context-based audio content. For example, the context-based audio content can be formatted for inclusion in a posting on a social media platform associated with a social media application.

In some embodiments, the one or more machine-learned models can be configured and/or trained to generate the one or more context-based audio segments. Training the one or more machine-learned models to generate the one or more context-based audio segments can comprise receiving training data. The training data can comprise training content data, training context data, and/or a corresponding plurality of ground-truth audio segments.

The training content data can comprise a plurality of training data inputs that can comprise a plurality of training images, a plurality of training text segments, a plurality of training audio segments, and/or a plurality of training video segments. The training context data can comprise a plurality of training locations associated with the training content data, a plurality of temporal indications associated with the training content data, training application information associated with the training content data, a plurality of search queries and/or search histories associated with the training content data, training information associated with a user and the training content data, and/or training event data associated with the training content data. In some embodiments, the training data can comprise a plurality of embeddings based on output from an embedding generation model that generated the plurality of embeddings based on the training data.

The ground-truth audio segments can comprise audio segments that are relevant and/or appropriate with respect to corresponding content (e.g., an image, audio segment, text segment, or video segment). For example, training data comprising an image of a horse and a prompt comprising a request for an uplifting song about horse racing can be associated with a relevant ground-truth audio segment that comprises a traditional horse racing song played on an erhu or violin.

Further, training the one or more machine-learned models can comprise generating and/or determining, based on inputting the training data into the machine-learned model, a plurality of predicted audio segments. Based on the received input, the one or more machine-learned models can perform one or more operations and generate an output comprising a plurality of predicted audio segments associated with the corresponding plurality of training data inputs. The output of the one or more machine-learned models can then be evaluated based on one or more comparisons of the plurality of predicted audio segments to a corresponding plurality of ground-truth audio segments associated with the training data.

Training the one or more machine-learned models can comprise determining a loss based on one or more differences between the plurality of predicted audio segments and the plurality of ground-truth audio segments. For example, a loss function can be used to determine the loss. The loss function can be used to evaluate the one or more differences between the plurality of predicted audio segments and the plurality of ground-truth audio segments. The loss can increase in proportion to a number of differences between the plurality of predicted audio segments and the plurality of ground-truth audio segments. For example, if there are seven differences between the plurality of predicted audio segments and the plurality of ground-truth audio segments, the loss can be greater than if there are two differences between the plurality of predicted audio segments and the plurality of ground-truth audio segments.

Further, the loss can increase in proportion to the magnitude of differences between the plurality of predicted audio segments and the plurality of ground-truth audio segments. For example, a predicted audio segment that is very different from a ground-truth audio segment (e.g., a predicted audio segment that comprises somber music for an image of people celebrating) can result in a greater loss than a predicted segment that is slightly different from a ground-truth audio segment (e.g., a predicted audio segment for a sporting event that has a slightly lower tempo than the ground-truth audio segment).

Training the one or more machine-learned models can comprise modifying a plurality of parameters of the one or more machine-learned models to minimize the loss. The plurality of parameters can be associated with detection, recognition, and/or classification of one or more features of the training data that can be used to determine the predicted audio segments. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameter can be associated with the plurality of predicted audio segments such that parameters that are more heavily weighted can contribute more to determining the predicted audio segments than parameters that are less heavily weighted. Over the plurality of iterations, the weights of the plurality of parameters can be modified to minimize the loss until a threshold loss that corresponds to a high accuracy of the one or more machine-learned models determining the plurality of predicted audio segments is achieved. For example, the loss can be minimized until a threshold loss associated with 99% accuracy is achieved by the machine-learned model.

The computing system can generate a link note which can comprise content (e.g., user generated content including context-based audio content) that can be associated with one or more web resources. Further, the content included in a link note can comprise one or more images, one or more text segments, one or more video segments, one or more audio segments, and/or one or more links associated with one or more web resources. For example, a link note can comprise a user’s description of a recipe for homemade noodles, an image of the noodles, and a link (e.g., a hyperlink) to a webpage with other user content (e.g., other recipes) that can be displayed in an interface (e.g., graphical user interface) of a web browser when search results are provided in response to a search for noodle recipes. In some embodiments, a link note can be indicated in in a separate interface (e.g., a link note interface) and/or as part of another interface (e.g., a web browser interface and/or search engine interface).

A link note can be associated with search results and can comprise a characterization of a search result and/or one or more web resources indicated in a search result. For example, a link note comprising a website review with one or more user comments indicating the quality and/or usefulness of a web site can be included alongside search results that include the website or other websites that are similar. Further, a link note can comprise information associated with a topic indicated in a search result and/or one or more web resources. For example, a link note comprising a book review (e.g., a video segment comprising a user’s analysis and/or rating of a particular book) can be included next to search results based on a search for reviews about the book indicated in the link note. In some embodiments, a plurality of link notes can be aggregated in a link notes interface and/or a collections interface that may be used to provide users with information on web resources including reviews and/or ratings of web resources.

A link note can comprise one or more links (e.g., one or more hyperlinks) to one or more web resources that can be associated with the context-based audio content. The one or more web resources can comprise resources that are accessible via a network (e.g., the Internet). Further, the one or more web resources can comprise one or more search results, one or more web sites, one or more web pages, one or more database entries, one or more documents, and/or one or more social media posts. For example, the context-based audio content can be based on content (e.g., an image of a bumblebee in flight) from a web page and the link note can comprise the context-based audio content including one or more context-based audio segments comprising music from the composer Nikolai Rimsky-Korsakov and a link to the web site from which the content comprising the image of the bee was obtained.

Further, a link note can comprise information associated with a time the link note was generated, modified, and/or sent; a user associated with the link note (e.g., the user that generated the link note and/or a recipient of the link note); a location at which the link note was generated or modified; an application that was used to generate the link note; and/or an email address associated with the link note (e.g., the email address of an individual user or business associated with the link note). One or more portions of the information in the link note can be selectively shared based on the preferences of the user sharing the link note. For example, a user can share their email address in link notes sent to one group of users and not share their email address in the link notes sent to a different group of users.

In some embodiments, a link note can be sent to one or more users and/or embedded in a web resource (e.g., a webpage). For example, a link note can be shared with one or more users from the sender of the link note’s contact list. Further, a link note can be embedded and/or included in a social media post, an online review, an online forum post, and/or a search result. For example, a link note comprising an image of a book cover and a context-based audio segment comprising music that is relevant to the book cover (e.g., Victorian era music associated with a book cover about a Victorian era detective) can be included in a book review that is provided as the result of a search for a review about that particular book.

The systems, methods, devices, and/or computer-readable media (e.g., tangible non-transitory computer-readable media) in the disclosed technology can provide a variety of technical effects and benefits including an improvement in the effectiveness with which content data comprising images, audio segments, text segments, and/or video segments is classified based on the detection, recognition, and/or classification of features (e.g., low-level visual features) of the content data. Further, improved generation of context-based audio content based on the detection, recognition, and/or classification of features of content data including images, audio, and/or video can assist a user by providing more relevant and/or appropriate audio segments that can accompany other content. The disclosed technology can also improve the effectiveness with which computational resources are used by leveraging one or more machine-learned models that are able to determine features (e.g., visual features, text features, and/or audio features) more efficiently.

Further, the disclosed technology can improve the effectiveness with which content is searched for, retrieved, and/or distributed from a variety of data sources. The large volume of content that is available on the Internet can present the arduous task of searching for relevant content. In many cases, the content a user searches for turns out to be irrelevant or deliberately misleading (e.g., misinformation). The ability to quickly generate relevant audio content that can be shared with trusted users in the form of a link note can significantly reduce inefficiencies involved in the search and retrieval of information comprising audio information.

Additionally, the disclosed technology can automatically generate context-based audio segments based on the processing (e.g., detection, classification, and/or recognition) of features of content data including images, text, audio, and/or video. For example, a video segment that can be used as part of a social media post can be automatically classified and together with context associated with the video (e.g., comments on the web page from which the video was obtained), relevant audio segments such as music and/or sound effects associated with the video can be generated using a machine-learned model. In this way, the time-consuming task of manually finding appropriate music or sound effects that is relevant to content data and/or adding relevant contextual audio to content data can be automatically performed by the disclosed technology.

As such, the disclosed technology can allow the user of a computing system to perform the technical task of generating or selecting relevant audio based on the detection, recognition, and/or classification of features of content data (e.g., images, text, audio, and/or video). As a result, users can be provided with the specific benefits of improved performance (classification performance and/or content generation performance) and more efficient use of system resources. Further, any of the specific benefits provided to users can be used to improve the effectiveness of a wide variety of devices and services including devices that use context-based audio content. Accordingly, the improvements offered by the disclosed technology can result in tangible benefits to a variety of devices and/or systems including mechanical, electronic, and computing systems associated with generating context-based audio content.

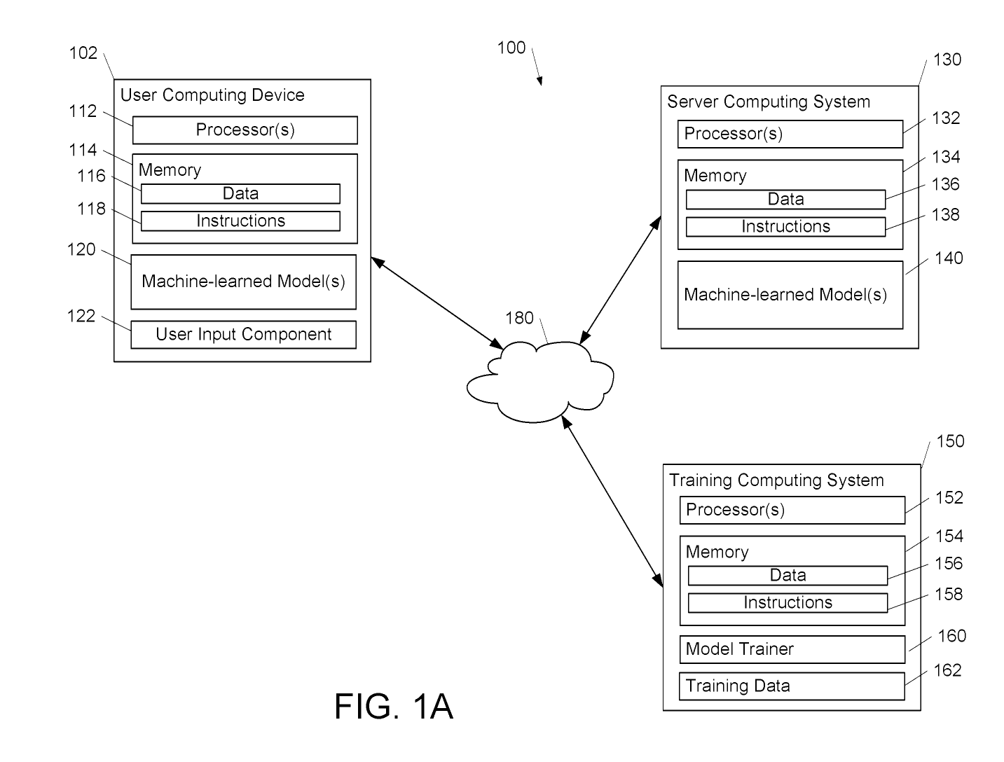

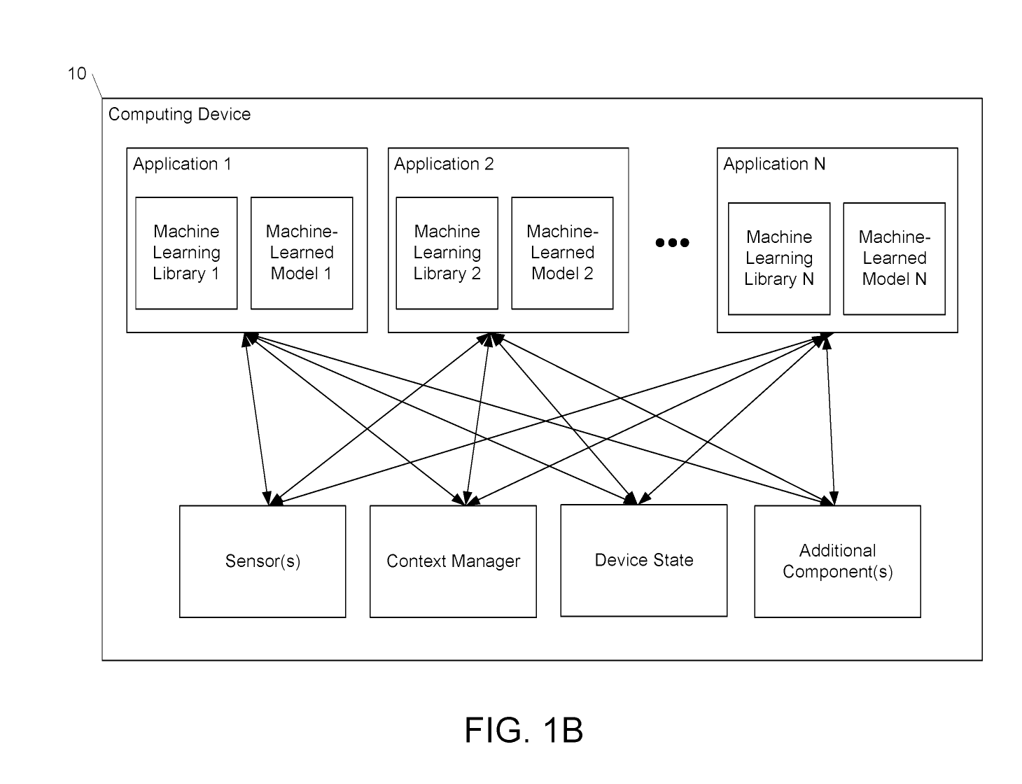

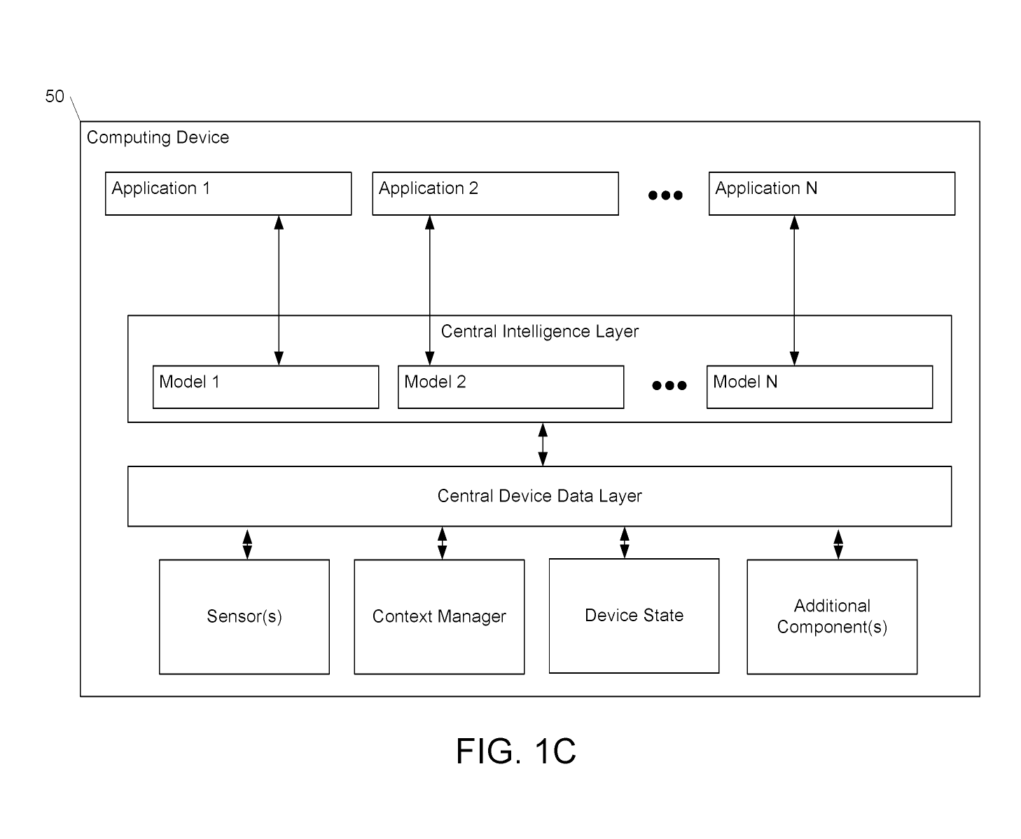

With reference now to the figures, example embodiments of the present disclosure will be discussed in further detail. FIG. 1A depicts a block diagram of an example of a computing system that can generate context-based audio content according to example embodiments of the present disclosure. System 100 includes a computing device 102, a server computing system 130, and a training computing system 150 that are communicatively coupled over a network 180.

The computing device 102 can comprise any type of computing device, including, for example, a personal computing device (e.g., laptop computing device or desktop computing device), a mobile computing device (e.g., smartphone or tablet), a gaming console or controller, an embedded computing device, a wearable computing device (e.g., a smartwatch), or any other type of computing device.

The computing device 102 includes one or more processors 112 and a memory 114. The one or more processors 112 can comprise any suitable processing device (e.g., a processor core, a microprocessor, an ASIC, an FPGA, a controller, and/or a microcontroller) and can be one processor or a plurality of processors that are operatively connected. The memory 114 can include one or more non-transitory computer-readable storage media, such as RAM, ROM, EEPROM, EPROM, flash memory devices, magnetic disks, and/or combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, comprising non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Further, the one or more machine-learned models 120 can comprise one or more large language models (LLMs), one or more generative adversarial networks (GANs), one or more encoders, one or more decoders, and/or one or more embedding models. Examples of one or more machine-learned models 120 are discussed with reference to FIGS. 1-10.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel context-based audio content generation operations across multiple instances of the one or more machine-learned models 120).

More particularly, the one or more machine-learned models 120 can comprise one or more machine-learned models (e.g., one or more LLMs) that are configured and/or trained to perform operations comprising receiving content data associated with one or more data modalities; determining one or more contexts associated with the content data; receiving prompt data comprising one or more prompts; generating, based on inputting the content data, the prompt data, and/or the context data based on the one or more contexts into a machine-learned model, one or more context-based audio segments based on the content data; and/or generating context-based audio content based on the one or more context-based audio segments.

Additionally or alternatively, one or more machine-learned models 140 can be included in or otherwise stored and implemented by the server computing system 130 that communicates with the computing device 102 according to a client-server relationship. For example, the one or more machine-learned models 140 can be implemented by the server computing system 130 as a portion of a web service (e.g., content data processing service, a context determination service, and/or a context-based audio content generation service). Thus, one or more machine-learned models 120 can be stored and implemented at the computing device 102 and/or one or more machine-learned models 140 can be stored and implemented at the server computing system 130.

The computing device 102 can also include one or more user input components 122 that receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an NPU, an FPGA, a controller, and/or a microcontroller) and can be one processor or a plurality of processors that are operatively connected. The memory 134 can include one or more non-transitory computer-readable storage media, such as RAM, ROM, EEPROM, EPROM, flash memory devices, magnetic disks, and/or combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Examples of one or more machine-learned models 140 are discussed with reference to FIGS. 1-10.

The computing device 102 and/or the server computing system 130 can train the one or more machine-learned models 120 and/or the one or more machine-learned models 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, and/or a microcontroller) and can be one processor or a plurality of processors that are operatively connected. The memory 154 can include one or more non-transitory computer-readable storage media, such as RAM, ROM, EEPROM, EPROM, flash memory devices, magnetic disks, and/or combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the one or more machine-learned models 120 and/or the one or more machine-learned models 140 stored at the computing device 102 and/or the server computing system 130 using various training or learning techniques (e.g., machine-learning techniques), such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a plurality of training iterations.

In some implementations, performing backwards propagation of errors can include performing truncated backpropagation through time. The model trainer 160 can perform a number of generalization techniques (e.g., weight decays, dropouts, and/or other generalization techniques.) to improve the generalization capability of the models being trained.

In particular, the model trainer 160 can train the one or more machine-learned models 120 and/or the one or more machine-learned models 140 based on a set of training data 162. The training data 162 can include various types of data. For example, the training data 162 can include content data, context data, prompt data, and/or other data that is associated with the detection, recognition, and/or classification of images, audio segments, and/or video segments; and the generation of context-based audio segments that can be used in context-based audio content. For example, the training data 162 can comprise training content comprising a plurality of training images and a corresponding plurality of ground-truth audio segments that are relevant and/or suitable to the plurality of training images; a plurality of training audio segments and a corresponding plurality of ground-truth audio segments that are in harmony with the plurality of training audio segments; and/or a plurality of training video segments and a corresponding plurality of ground-truth audio segments that are relevant and/or suitable to the plurality of training video segments. The training data 162 can comprise a plurality of training prompts that can comprise information associated requests or information associated with the training content (e.g., a prompt requesting the generation of a particular genre of music or a prompt indicating describing content comprising an image). Further, the training data 162 can comprise a plurality of training contexts that comprise information associated with contexts associated with the training content (e.g., locations, temporal indications, events, applications, search queries, and/or users associated with the training content). The model trainer 160 can train and/or retrain the one or more machine-learned models 120 and/or the one or more machine-learned models 140 based on additional data from the training data 162 which can comprise additional content data (e.g., updated content data), additional context data, additional prompt data, new types of content data, context data, and/or prompt data (e.g., new types of content data based on new content formats), and/or one or more modifications to existing content data, context data, and/or prompt data.

In some implementations, if a user has provided consent (e.g., the user provides affirmative consent for another party to use the user’s content data), the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can comprise any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification can be used in a variety of tasks, applications, and/or use cases. In some implementations, the input to the machine-learned model(s) of the present disclosure can be text or natural language data. The machine-learned model(s) can process the text or natural language data to generate an output (e.g., based on inputting queries from a user the machine-learned model(s) can process and generate an analysis comprising one or more explanations and visualizations associated with the queries and image data of the user). As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can comprise speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can comprise latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can comprise statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can comprise sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task can be an audio compression task. The input can include audio data and the output can comprise compressed audio data. In another example, the input includes visual data (e.g., one or more images or videos), the output comprises compressed visual data, and the task is a visual data compression task. In another example, the task can comprise generating an embedding for input data (e.g., input audio data or visual data).

In some cases, the input includes audio data representing a spoken utterance and the task is a speech recognition task. The output can comprise a text output that is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example computing device that can generate context-based audio content comprising context-based audio segments according to example embodiments of the present disclosure. A computing device 10 can be a user computing device or a server computing device.

The computing device 10 can include a number of applications (e.g., applications 1 through N). Each application contains its own machine-learned library and machine-learned model(s). For example, each application can include a machine-learned model. Example applications include a content data processing application, a context data processing application, a prompt data processing application, a social media application, a text messaging application, an email application, a dictation application, a virtual keyboard application, and/or a browser application (e.g., a web browser application).

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that can generate context-based audio content comprising context-based audio segments according to example embodiments of the present disclosure. A computing device 50 can be a user computing device or a server computing device.

The computing device 50 includes a number of applications (e.g., applications 1 through N). Each application is in communication with a central intelligence layer. Example applications include a context-based audio content generation application (e.g., an application that is used to process content data, prompt data, and/or context data, generate audio segments based on the content data and/or the context data, and generate context-based audio content based on one or more context-based audio segments), a social media application, a text messaging application, an email application, a dictation application, a virtual keyboard application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a content manager, a context manager, a prompt manager, a device state component, and/or additional components. In some implementations, the central device data layer can communicate with each device component using an API (e.g., a private API).

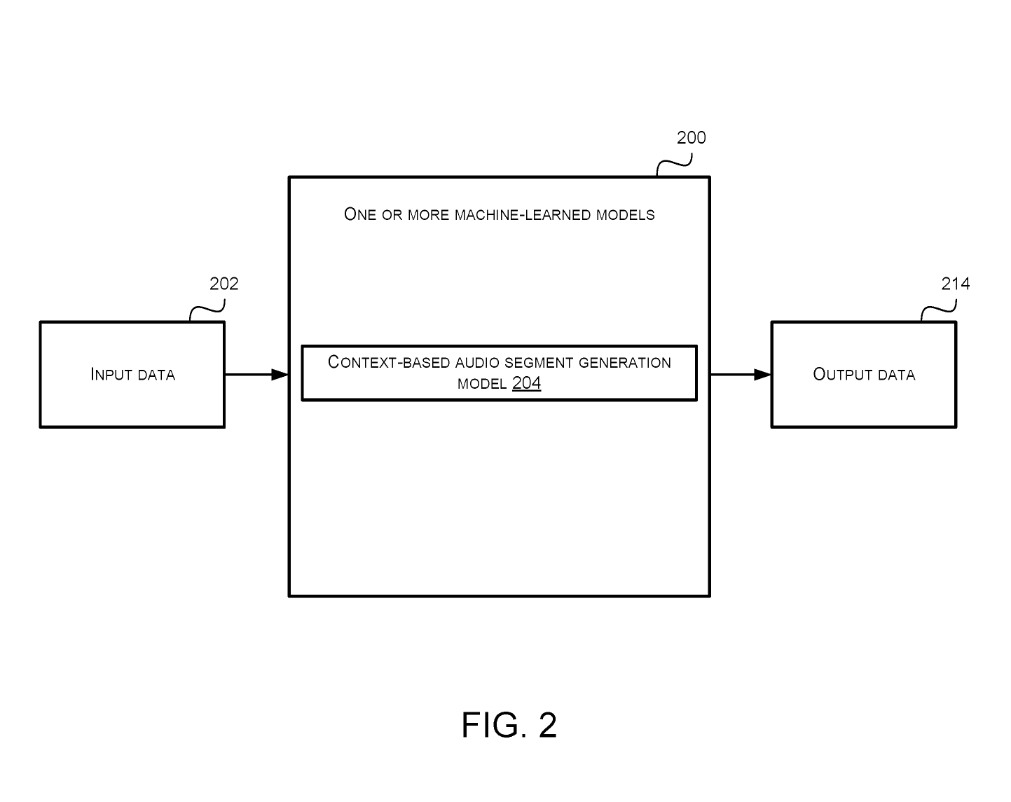

FIG. 2 depicts a block diagram of examples of machine-learned models according to example embodiments of the present disclosure. In some implementations, the one or more machine-learned models 200 can be trained to receive input data 202 that can comprise content data associated with one or more data modalities (e.g., images, audio segments, text segments, and/or video segments), prompt data associated with the content data, and/or context data associated with the content data (e.g., location data, temporal data, event data, application data, search data, and/or information associated with a user). As a result of receipt of the input data 202 the one or more machine-learned models 200 can generate output data 214 that can comprise one or more context-based audio segments based on detection, recognition, and/or classification of one or more features of the content data, the prompt data, and/or the context data.

In some implementations, the one or more machine-learned models 200 can include a content processing model 204 that is operable to generate context-based audio segments based on the input data 202 (e.g., the content data, the prompt data, and/or the context data).

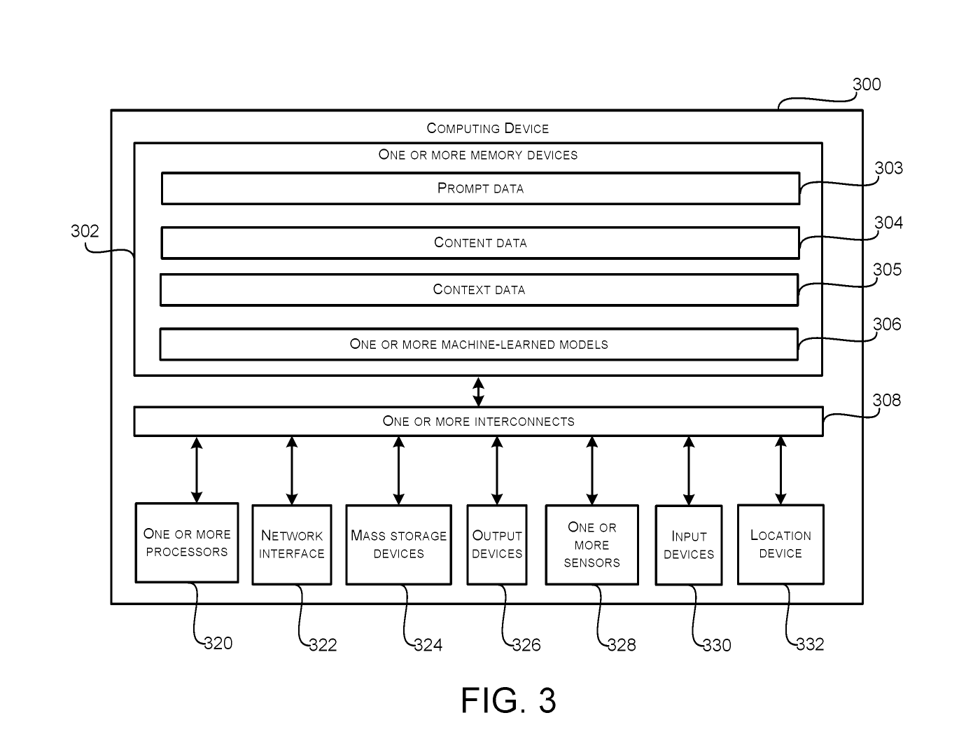

FIG. 3 depicts an example of a computing device according to example embodiments of the present disclosure. A computing device 300 can include one or more features and/or capabilities of the computing device 102, the server computing system 130, and/or the training computing system 150. Furthermore, the computing device 300 can perform one or more actions and/or operations performed by the computing device 102, the server computing system 130, and/or the training computing system 150, which are described with respect to FIG. 1A.

As shown in FIG. 3, the computing device 300 can include one or more memory devices 302, prompt data 303, content data 304, context data 305, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., audio segments) based on content detected by the one or more sensors 328 (e.g., images captured by a camera of the device 300) of the computing device 300 and/or data that is received from another computing device (e.g., content data that is generated by a remote computing device).

The one or more memory devices 302 can store information and/or data (e.g., the content data 304, the context data 305, and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations comprising receiving content data associated with one or more data modalities, determining contexts associated with the content data, generating, based on inputting content data, prompt data, and/or context data based on the one or more contexts into a machine-learned model, one or more context-based audio segments based on the content data, and/or generating context-based audio content based on the one or more context-based audio segments.

The prompt data 303 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. The prompt data 303 can be generated based on one or more inputs via the one or more input devices 330. For example, the prompt data can comprise text based on inputs via a keyboard (e.g., mechanical keyboard and/or touchscreen keyboard), touch inputs via a touchscreen, and/or audio input via a microphone. In some embodiments, the prompt data 303 can be received from one or more computing systems (e.g., the server computing system 130 that is depicted in FIG. 1) which can include one or more computing systems that are remote from the computing device 300. The prompt data 303 can comprise one or more text segments (e.g., a text prompt) and/or one or more audio segments (e.g., an audio prompt).

The content data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. In some embodiments, the content data 304 can be received from one or more computing systems (e.g., the server computing system 130 that is depicted in FIG. 1) which can include one or more computing systems that are remote from the computing device 300. The content data 304 can comprise one or more images, one or more audio segments, one or more video segments, and/or one or more text segments. Further, the content data 304 can comprise information (e.g., metadata) associated with one or more locations at which the content data 304 was generated, modified, and/or accessed; one or more times at which the content data 304 was generated, modified, and/or accessed; one or more events associated with the content data 304; one or more applications associated with the content data 304; one or more search queries associated with the content data 304; and/or one or more users associated with the content data 304.

The context data 305 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the context data 305 can include information associated with one or more contexts of the content data 304 and/or a user of the computing device 300 including location data, temporal data, event data, application data, search data, and/or information associated with a user. In some embodiments, the context data 305 can be received from one or more computing systems (e.g., the server computing system 130 that is depicted in FIG. 1) which can include one or more computing systems that are remote from the computing device 300.

The one or more machine-learned models 306 (e.g., the one or more machine-learned models 120, the one or more machine-learned models 140, and/or the machine-learned models 200) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 306 can be configured and/or trained to perform operations comprising receiving content data associated with one or more data modalities, determining contexts associated with the content data, generating, based on inputting the prompt data, the content data and/or context data based on the one or more contexts into a machine-learned model, one or more context-based audio segments based on the content data, and/or generating context-based audio content based on the one or more context-based audio segments. In some embodiments, the one or more machine-learned models 306 can be received from one or more computing systems (e.g., the server computing system 130 that is depicted in FIG. 1) which can include one or more computing systems that are remote from the computing device 300.

The one or more interconnects 308 can include one or more interconnects or buses that can be used to send and/or receive one or more signals (e.g., electronic signals) and/or data (e.g., the prompt data 303, the content data 304, the context data 305, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the prompt data, the content data 304, the context data 305, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., content data, prompt data, and/or context data) from other computing devices. The one or more mass storage devices 324 (e.g., a hard disk drive and/or a solid-state drive) can be used to store data including the content data 304 and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on images, audio segments, and/or video segments associated with the content data 304.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which can be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including context-based audio content based on the prompt data 303, the content data 304, and/or the context data 305. The one or more memory devices 302 can be used to operate various applications including a mobile operating system developed specifically for mobile devices. As such, the one or more memory devices 302 can store instructions that allow the software applications to access data including data associated with the generation of context-based audio segments associated with the prompt data 303, the content data 304, and/or the context data 305. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

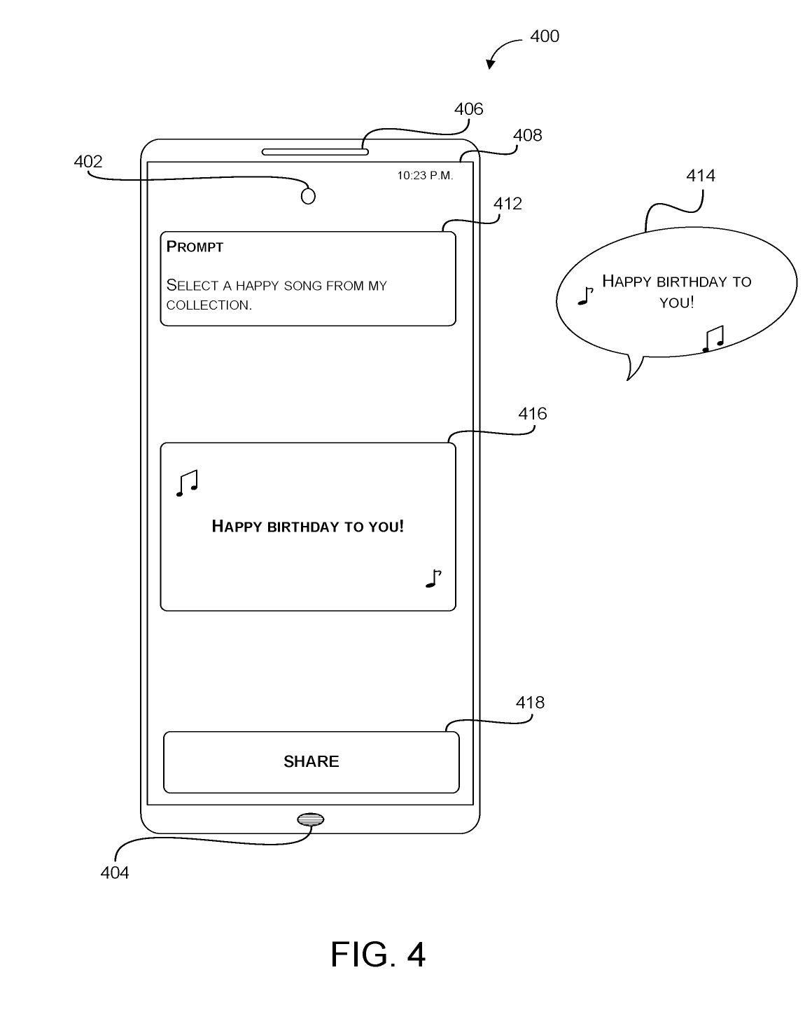

FIG. 4 depicts an example of selecting context-based audio content according to example embodiments of the present disclosure. A computing device 400 can include one or more features and/or capabilities of the computing device 102, the server computing system 130, the training computing system 150, and/or the computing device 300. Furthermore, the computing device 400 can perform one or more actions and/or operations that can be performed by the computing device 102, the server computing system 130, the training computing system 150, and/or the computing device 300.

The computing device 400 can include an imaging component 402, an audio input component 404, an audio output component 406, a display component 408, a prompt 412, a context-based audio segment 414, context-based audio content 416, and/or interface element 418.

The computing device 400 can be configured to perform one or more operations comprising sending, receiving, processing, and/or generating data comprising context-based audio content, prompt data, context data, and/or other data received by the computing device 400. In some embodiments, the computing device 400 can comprise a mobile computing device (e.g., a smartphone, a tablet computing device, a laptop computing device, and/or a wearable computing device) that can be configured to process data locally and/or receive data from a remote source (e.g., a remote computing device that stores and/or processes data that can comprise content data, prompt data, and/or context data). The data (e.g., prompt data and/or context data) received by the computing device 400 can be used to generate output comprising one or more context-based audio segments (e.g., the context-based audio segment 414) based on the one or more prompts (e.g., the prompt 412). Further, the computing device 400 can be configured to generate output comprising context-based audio content (e.g., context-based audio content 416) that can comprise the context-based audio segment 414.

Further, the computing device 400 can implement an interface (e.g., a graphical user interface) that is configured to receive one or more inputs (e.g., touch inputs and/or audio inputs) from a user and perform operations that can comprise generating the context-based audio segment 414 and/or the context-based audio content 416. In this example, the computing device 400 has received the prompt 412 which indicates “SELECT A HAPPY SONG FROM MY COLLECTION.”

The computing device 400 can determine one or more contexts based on information associated with the user that generated the prompt 412. For example, the computing device 400 can access the user’s song collection data and determine songs that the user has played recently and/or songs that are associated with happy themes such as celebrating, dancing, and/or merry making. Further, the computing device 400 can access a user’s calendar data to determine if there are upcoming events such as birthdays or holidays that are associated with happy themes. In this example, the calendar data indicates that the prompt 412 was made on the user’s birthday.

The computing device 400 can use the prompt 412 and/or context data (e.g., context data associated with the prompt 412) as input to one or more machine-learned models that can be implemented on the computing device 400 and/or implemented on a remote computing device that is able to send data to and/or receive data from the computing device 400. The one or more machine-learned models can be configured and/or trained to recognize and/or classify one or more features of the context data and/or the prompt 412. For example, the one or more machine-learned models can perform language processing operations on the prompt 412 to determine that the prompt 412 comprises a request for a particular class (“HAPPY”) of song. Further, the one or more machine-learned models can use the context (e.g., the song collection data and/or the calendar data indicating potential celebratory events) to determine the types of songs to select from the user’s song collection. The one or more machine-learned models can then use the context and/or prompt features that were determined to generate the context-based audio segment 414 which comprises audio indicating “HAPPY BIRTHDAY TO YOU!”

The context-based audio segment 414 can be generated via the audio output component 406. In this example, the context-based audio segment 414 indicates “HAPPY BIRTHDAY TO YOU.” The context-based audio segment 414 can be based on the prompt 412 and/or the context data (e.g., context data associated with the prompt 412).

The computing device 400 can generate the context-based audio content 416. In some embodiments, the computing device 400 can generate a text indication based on the context-based audio content 416. The context-based audio content 416 can be displayed on the display component 408 and can comprise the context-based audio segment 414 which can be generated via the audio output component 406 or via an audio output component of another device that receives the context-based audio content 416. Additionally, the interface element 418 which indicates “SHARE” can be used to send the context-based audio content 416 via one or more applications comprising a social media application, a text message application, and/or an email application. Further, the context-based audio content 416 can be used to generate a link note that can be shared with one or more users, one or more user groups, and/or embedded in a web resource. The context-based audio content 416 can be shared based on the computing device 400 detecting a user touching the portion of the user interface that comprises the interface element 418.

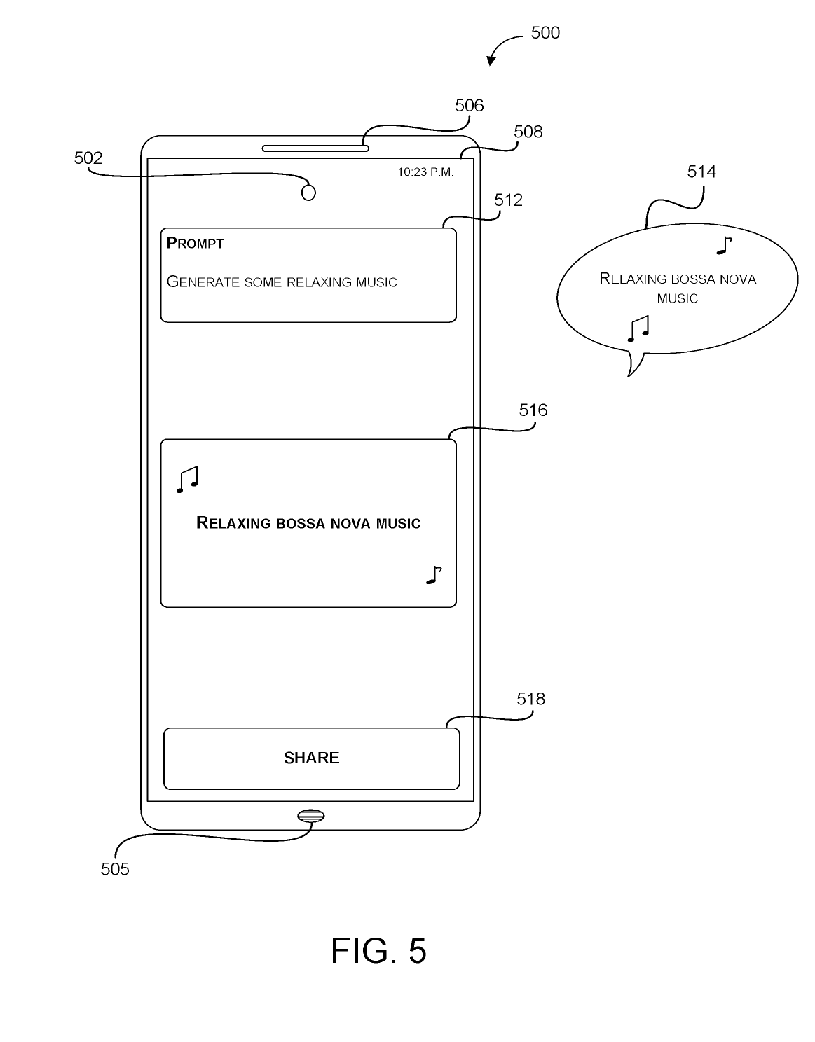

FIG. 5 depicts an example of generating context-based audio content according to example embodiments of the present disclosure. A computing device 500 can include one or more features and/or capabilities of the computing device 102, the server computing system 130, the training computing system 150, the computing device 300, and/or the computing device 400. Furthermore, the computing device 500 can perform one or more actions and/or operations that can be performed by the computing device 102, the server computing system 130, the training computing system 150, the computing device 300, and/or the computing device 500.

The computing device 500 can include an imaging component 502, an audio input component 505, an audio output component 506, a display component 508, a prompt 512, a context-based audio segment 514, context-based audio content 516, and/or interface element 518.

The computing device 500 can be configured to perform one or more operations comprising sending, receiving, processing, and/or generating data comprising context-based audio content, prompt data, context data, and/or other data received by the computing device 500. In some embodiments, the computing device 500 can comprise a mobile computing device (e.g., a smartphone, a tablet computing device, a laptop computing device, and/or a wearable computing device) that can be configured to process data locally and/or receive data from a remote source (e.g., a remote computing device that stores and/or processes data that can comprise content data, prompt data, and/or context data). The data (e.g., prompt data and/or context data) received by the computing device 500 can be used to generate output comprising one or more context-based audio segments (e.g., the context-based audio segment 514) based on the one or more prompts (e.g., the prompt 512). Further, the computing device 500 can be configured to generate output comprising context-based audio content (e.g., context-based audio content 516) that can comprise the context-based audio segment 514.

Further, the computing device 500 can implement an interface (e.g., a graphical user interface) that is configured to receive one or more inputs (e.g., touch inputs and/or audio inputs) from a user and perform operations that can comprise generating the context-based audio segment 514 and/or the context-based audio content 516. In this example, the computing device 500 has received the prompt 512 which indicates “GENERATE SOME RELAXING MUSIC.”

The computing device 500 can determine one or more contexts based on information associated with the user that generated the prompt 512. For example, the computing device 500 can access the user’s location and determine that the user is near a beach. Further, the computing device 500 can access a user’s calendar data to determine that the user is on vacation. The computing device 500 can also access a user’s search history and browser history to determine that the user has listened to a large number of Bossa Nova songs in the past month.

The computing device 500 can use the prompt 512 and/or context data (e.g., context data associated with the prompt 512) as input to one or more machine-learned models that can be implemented on the computing device 500 and/or implemented on a remote computing device that is able to send data to and/or receive data from the computing device 500. The one or more machine-learned models can be configured and/or trained to recognize and/or classify one or more features of the context data and/or the prompt 512. For example, the one or more machine-learned models can perform language processing operations on the prompt 512 to determine that the prompt 512 comprises a request for a particular class (“RELAXING”) of music. Additionally, the one or more machine-learned models can determine that the use of the word “SOME” can indicate that the user may be requesting that more than one context-based audio segment be generated. Further, the one or more machine-learned models can use the context (e.g., the location of the user near a beach, the calendar data indicating the user is on vacation, and the types of music the user has recently listened to) to determine the types of songs to generate. The one or more machine-learned models can comprise a generative model that is configured and/or trained to generate music based on the context and/or prompt features that were processed. In this example, the one or more machine-learned models generate the context-based audio segment 514 which comprises relaxing instrumental music. Based on the context data, the context-based audio segment 514 can comprise instrumental music that is in a Bossa Nova style that has a slow tempo and does not have loud segments or heavy use of drums. The context-based audio segment 514 can be generated via the audio output component 506.

The computing device 500 can generate the context-based audio content 516. In some embodiments, the computing device 500 can generate a text indication based on the context-based audio content 516. In this example, the context-based audio content 516 comprises the indication “RELAXING BOSSA NOVA MUSIC” and the context-based audio segment. The context-based audio content 516 can be displayed on the display component 508 and can comprise the context-based audio segment 514 which can be generated via the audio output component 506 or via an audio output component of another device that receives the context-based audio content 516. Additionally, the interface element 518, which indicates “SHARE” can be used to send the context-based audio content 516 via one or more applications comprising a social media application, a text message application, and/or an email application. Further, the context-based audio content 516 can be used to generate a link note that can be shared with one or more users, one or more user groups, and/or embedded in a web resource. The context-based audio content 516 can be shared based on the computing device 500 detecting a user touching the portion of the user interface that comprises the interface element 518.

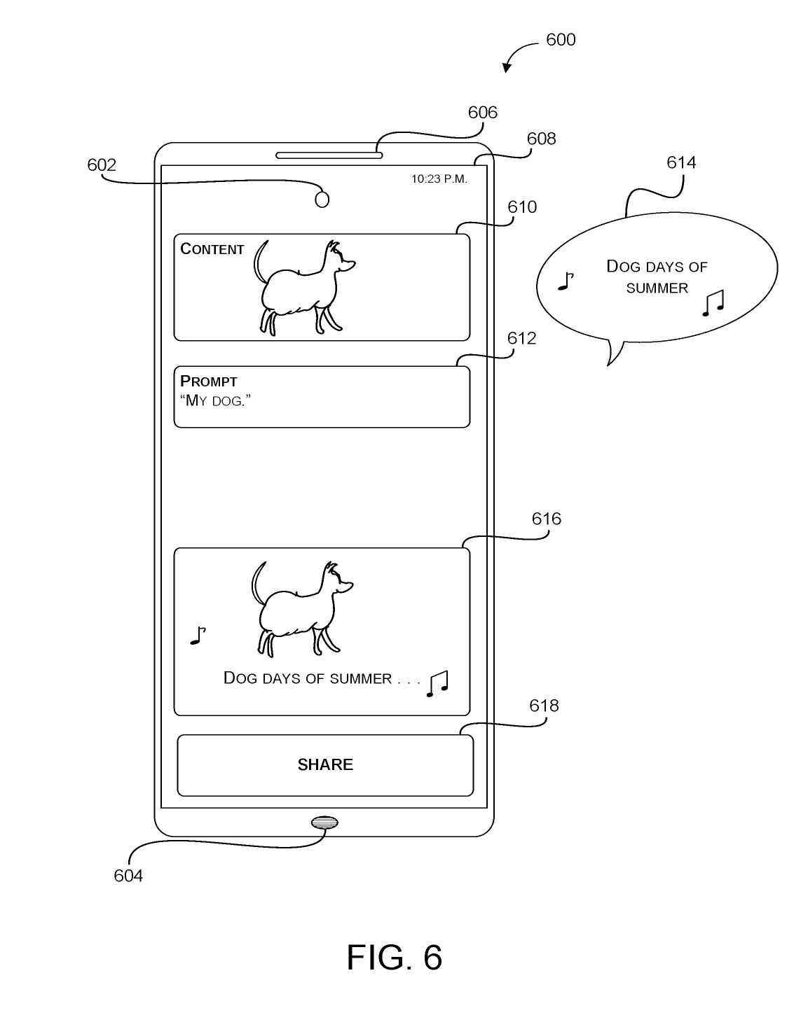

FIG. 6 depicts an example of generating context-based audio content according to example embodiments of the present disclosure. A computing device 600 can comprise one or more features and/or capabilities of the computing device 102, the server computing system 130, the training computing system 150, the computing device 300, and/or the computing device 500.

The computing device 600 can include an imaging component 602, an audio input component 604, an audio output component 606, a display component 608, content 610, a prompt 612, a context-based audio segment 614, context-based audio content 616, and/or interface element 618.

The computing device 600 can be configured to perform one or more operations comprising sending, receiving, processing, and/or generating data comprising content data (e.g., content data based on the content 610), prompt data, context data, and/or other data received by the computing device 600. In some embodiments, the computing device 600 can comprise a mobile computing device (e.g., a smartphone, a tablet computing device, a laptop computing device, and/or a wearable computing device) that can be configured to process data locally and/or receive data from a remote source (e.g., a remote computing device that stores and/or processes data that can comprise content data, prompt data, and/or context data). The data (e.g., content data, prompt data, and/or context data) received by the computing device 600 can be used to generate output comprising one or more context-based audio segments (e.g., the context-based audio segment 614) based on the content 610 and/or one or more prompts (e.g., the prompt 612). Further, the computing device 600 can be configured to generate output comprising context-based audio content (e.g., context-based audio content 616) that can comprise the content 610 and/or the context-based audio segment 614.

Further, the computing device 600 can implement an interface (e.g., a graphical user interface) that is configured to receive one or more inputs (e.g., touch inputs and/or audio inputs) from a user and perform operations that can comprise generating the context-based audio segment 614 and/or the context-based audio content 616.

In this example, the computing device 600 has received the content 610, which can comprise an image and/or video segment of a dog that is displayed on the display component 608. In some embodiments, the content 610 can comprise audio which can be muted or played at a reduced volume when the context-based audio segment 614 is generated. Further, the computing device 600 has received the prompt 612, which is displayed on the display component 608. The prompt 612 indicates “MY DOG.” In some embodiments, the prompt 612 is optional and the context-based audio segment 614 and/or the context-based audio content 616 can be generated without receiving and/or using the prompt 612.

The computing device 600 can determine one or more contexts based on content data associated with the content 610 and/or the prompt 612. For example, the computing device 600 can determine that the content data associated with the content 610 comprises location data (e.g., a latitude, longitude, and/or altitude) indicating the location at which the image of the dog was captured. The location at which the image of the dog was captured can correspond to a known location at which the user of the computing device 600 resides. Further, the computing device 600 can determine that the image of the dog was captured in the month of July, during the summer.

The computing device 600 can use content data (e.g., content data associated with the content 610), the prompt 612, and/or context data (e.g., context data associated with the content 610 and/or the prompt 612) as input to one or more machine-learned models that can be implemented on the computing device 600 and/or implemented on a remote computing device that is able to send data to and/or receive data from the computing device 600. The one or more machine-learned models can be configured and/or trained to recognize and/or classify one or more features of the content data, the context data, and/or the prompt 612. For example, the one or more machine-learned models can perform object detection, object recognition operations and/or image classification operations to determine that the content 610 is an image of a dog. Further, the one or more machine-learned models can recognize and/or classify one or more features of the prompt 612 and determine that the prompt 612 is a statement indicating a relationship of the user to the dog. The one or more machine-learned models can also use the context (e.g., the location data indicating that the content 610 was captured at the location at which the user resides and the temporal indication indicating that the image was captured during the summer) to determine that the image of the dog was captured at the user’s residence. The one or more machine-learned models can then use the content, context, and/or prompt features that were determined to generate (e.g., generate the context-based audio segment using a generative model) or select (e.g., select from a music repository of a user) the context-based audio segment 614 which comprises audio comprising a song indicating “DOG DAYS OF SUMMER.”

The context-based audio segment 614 can be generated via the audio output component 606. In this example, the context-based audio segment 614 indicates “DOG DAYS OF SUMMER.” The context-based audio segment 614 can be based on the content data (e.g., content data associated with the content 610) and/or context data (e.g., context data associated with the content 610 and/or the prompt 612).

The computing device 600 can generate the context-based audio content 616. The context-based audio content 616 can be generated via the audio output component 606. In some embodiments, the computing device 600 can generate a text indication based on the context-based audio content 616. In this example, the text indication “DOG DAYS OF SUMMER” is included as a caption of the context-based audio content below the image of the dog. The context-based audio content 616 can be displayed on the display component 608 and can comprise the content 610 and/or the context-based audio segment 614 which can be generated via the audio output component 606 or via an audio output component of another device that receives the context-based audio content 616. Additionally, the interface element 618 which indicates “SHARE” can be used to send the context-based audio content 616 via one or more applications comprising a social media application, a text message application, and/or an email application. Further, the context-based audio content 616 can be used to generate a link note that can be shared with one or more users, one or more user groups, and/or embedded in a web resource. The context-based audio content 616 can be shared based on the computing device 600 detecting a user touching the portion of the user interface that comprises the interface element 618.

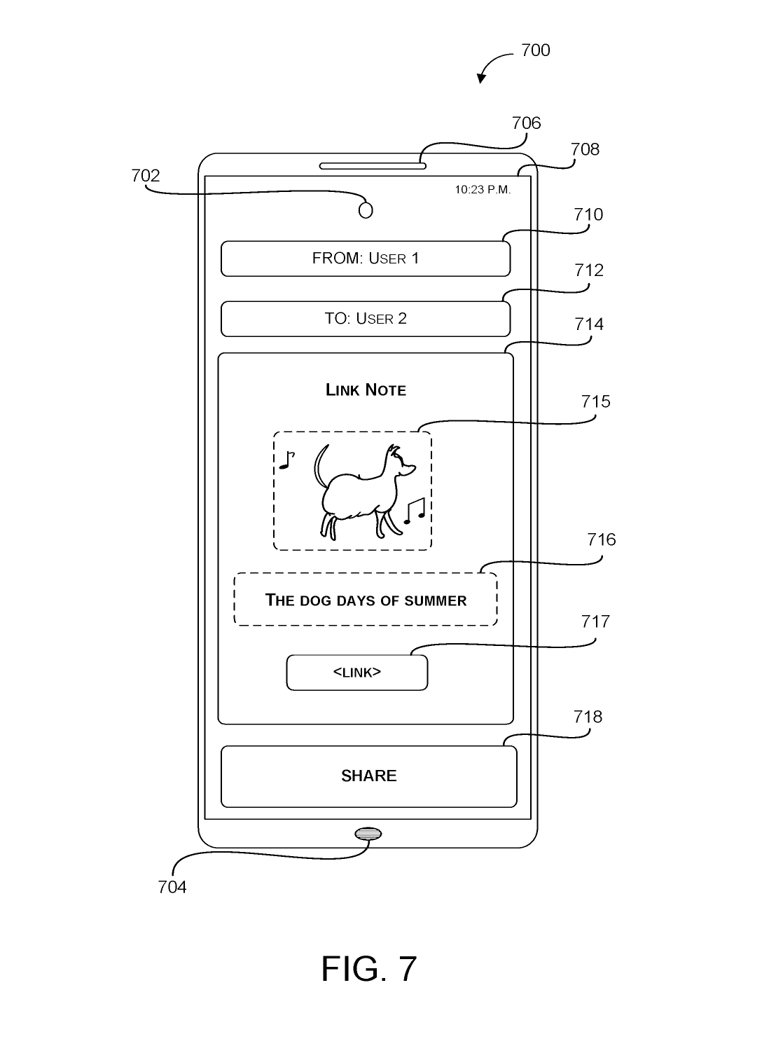

FIG. 7 depicts an example of a link note based on context-based audio content according to example embodiments of the present disclosure. A computing device 700 can include one or more features and/or capabilities of the computing device 102, the server computing system 130, the training computing system 150, the computing device 300, and/or the computing device 500.

The computing device 700 can include an imaging component 702, an audio input component 704, an audio output component 706, a display component 708, sender indication 710, a receiver indication 712, a link note 714, context-based audio content 715, audio segment title 716, link 717, and/or interface element 718.

The computing device 700 can be configured to perform one or more operations comprising sending, receiving, processing, and/or generating data comprising link note data (e.g., link note data based on the link note 714), content data, context data, prompt data, and/or other data received by the computing device 700. Further, the computing device 700 can be configured to generate the link note 714.

In this example, the computing device 700 has generated and/or accessed the link note 714 which comprises context-based audio content 715 comprising an image of a dog and an audio segment comprising music, the audio segment title 716 which indicates “THE DOG DAYS OF SUMMER” and a link 717 that indicates “<LINK>” and comprises a link to a web resource (e.g., a social media posting from which the context-based audio content 715 was obtained) displayed on the display component 708. In some embodiments, the computing device 700 can generate and/or access the link note 714 based on one or more interactions by the user with an interface element (e.g., the interface element 618 that is described with respect to FIG. 6). Further, the computing device 700 can generate the sender indication 710 which indicates “FROM: USER 1” and can be used to indicate the user that is sending the link note 714. The computing device 700 can also generate the receiver indication 712 which indicates “TO: USER 2” and can be used to indicate the user that may receive the link note 714.

Additionally, the interface element 718 which indicates “SHARE” can be used to send the link note 714 to one or more users (e.g., “USER 2” indicated in the receiver indication 712). For example, the link note 714 can be shared based on the computing device 700 detecting a user touching the portion of the user interface that comprises the interface element 718. In some embodiments, the link note 714 can be included in one or more web resources. For example, the link note 714 can be included in a search result for dogs or the song “THE DOG DAYS OF SUMMER,” a social media post, and/or a review website.

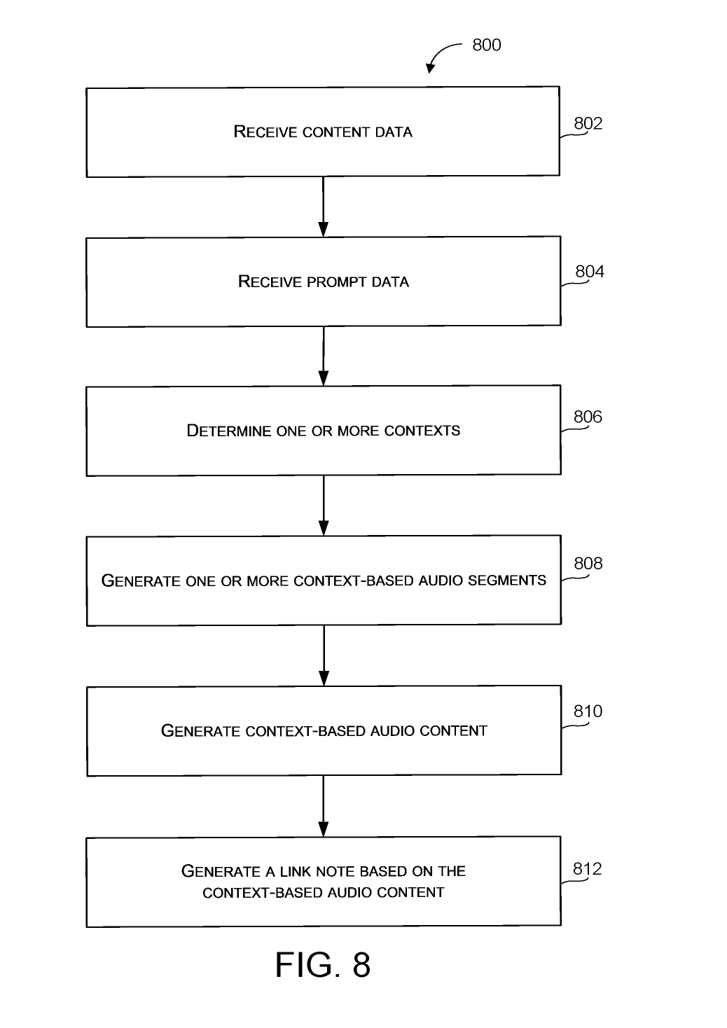

FIG. 8 depicts a flow chart diagram of an example method of generating context-based audio content according to example embodiments of the present disclosure. One or more portions of the method 800 can be executed and/or implemented on one or more computing devices or computing systems comprising, for example, the computing device 102, the server computing system 130, the training computing system 150, and/or the computing device 300. Further, one or more portions of the method 800 can be executed or implemented as an algorithm on the hardware devices or systems disclosed herein. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include receiving content data that can comprise content associated with one or more data modalities. For example, the server computing system 130 can receive content data comprising a video segment of a rowing regatta being contested. The content data can be received from a local device and/or from a remote source (e.g., a remote computing system) via a network such as the network 180.

At 804, the method 800 can include receiving prompt data that can comprise one or more prompts associated with the content data. For example, the one or more prompts can comprise a prompt to generate a song based on content comprising an image of a birthday cake. By way of further example, the server computing system 130 can receive data (e.g., prompt data) comprising one or more text-based prompts and/or one or more audio prompts via a microphone. The prompt data can be received from a local device and/or from a remote source (e.g., a remote computing system) via a network such as the network 180.

At 806, the method 800 can include determining one or more contexts associated with the content data. Context data can be generated based on the one or more contexts. For example, the server computing system 130 can access the web browser of a user to determine context comprising the web pages that the user had visited within a predetermined period of time (e.g., a predetermined period of time prior to the content data being received). Further, the server computing system 130 can generate context data based on the context comprising the web pages that the user had made within a predetermined period of time prior (e.g., one minute, one hour, or one day).

At 808, the method 800 can include generating and/or determining, based on inputting the content data, prompt data, and/or context data based on the one or more contexts into one or more machine-learned models, one or more context-based audio segments based on the content data. The one or more machine-learned models can be configured and/or trained to generate the one or more context-based audio segments based on detection, recognition, and/or classification of one or more features of the content data and the context data. For example, the server computing system 130 can implement one or more machine-learned models that are configured and/or trained to generate one or more context-based audio segments based on input comprising a video segment and context associated with web pages associated with the content of the video segment.

At 810, the method 800 can include generating context-based audio content based on the one or more context-based audio segments. For example, the server computing system 130 can generate a video segment comprising the video segment of content data and one or more audio segments comprising dramatic music that is relevant and/or suitable to the video segment. For example, a video of a sculler gracefully sculling down a tranquil river can include one or more context-based audio segments comprising classical music.

At 812, the method 800 can include generating a link note based on the context-based audio content. For example, the server computing system 130 can generate a link note comprising the context-based audio content and a link (e.g., a hyperlink) to a social media post associated with the content of the context-based audio content. For example, if the context-based audio content comprises a video segment and music, the link note can comprise a link to the website from which the video segment was obtained and/or a link to the source of the one or more context-based audio segments.

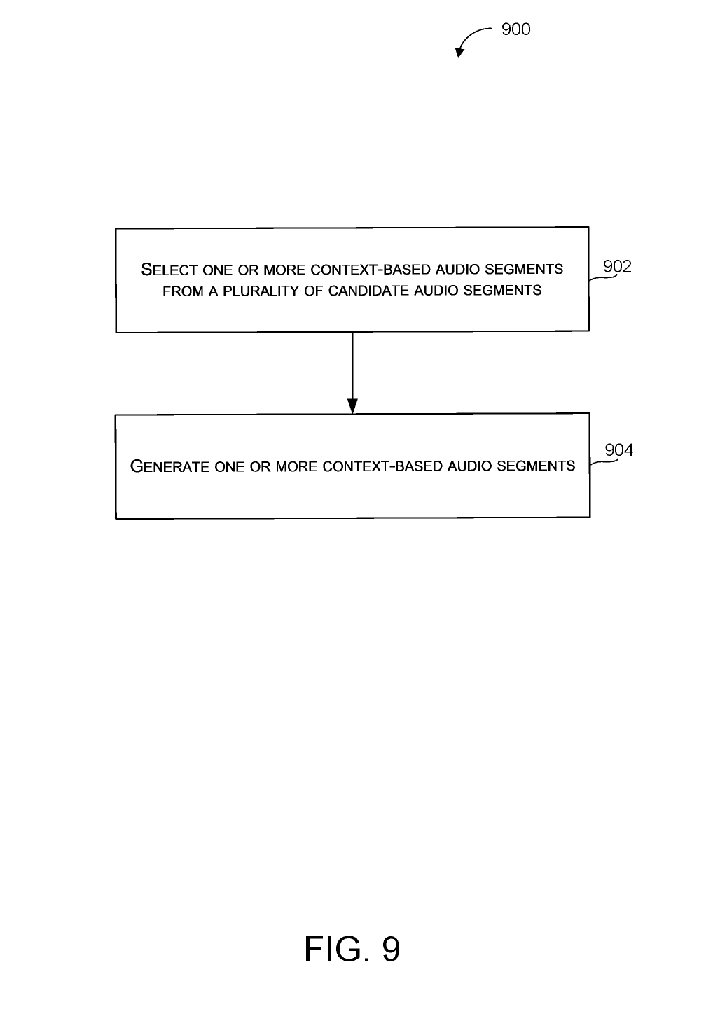

FIG. 9 depicts a flow chart diagram of an example method of training machine-learned models to generate context-based audio segments according to example embodiments of the present disclosure. One or more portions of the method 900 can be executed and/or implemented on one or more computing devices or computing systems comprising, for example, the computing device 102, the server computing system 130, the training computing system 150, and/or the computing device 300. Further, one or more portions of the method 900 can be executed or implemented as an algorithm on the hardware devices or systems disclosed herein. In some embodiments, one or more portions of the method 900 can be performed as part of the method 800 that is described with respect to FIG. 8. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include selecting the one or more context-based audio segments from a plurality of candidate audio segments. For example, the computing device 102 can access audio data comprising a plurality of candidate audio segments (e.g., a song collection of a user associated with the content). The one or more machine-learned models can be configured and/or trained to determine the one or more features of the content, context, and/or prompts and select one or more candidate audio segment from the plurality of candidate audio segments based on the similarity of the one or more features of the candidate audio segment to the determined one or more features based on the content data, the context data, and/or one or more prompts.

At 904, the method 900 can include generating the one or more context-based audio segments based on recognition of the one or more features of the content data or the context data. The one or more machine-learned models can comprise one or more generative models that are configured and/or trained to generate the one or more context-based audio segments. The one or more machine-learned models can generate the one or more context-based audio segments based on input comprising the content, the context data, and/or one or more prompts. For example, the server computing system 130 can implement one or more machine-learned models comprising an audio diffusion model that is configured to generate one or more context-based audio segments based on input comprising the content, the context data, and/or one or more prompts. The one or more context-based audio segments can comprise music based on the content and/or a user’s musical preferences based on the context data.

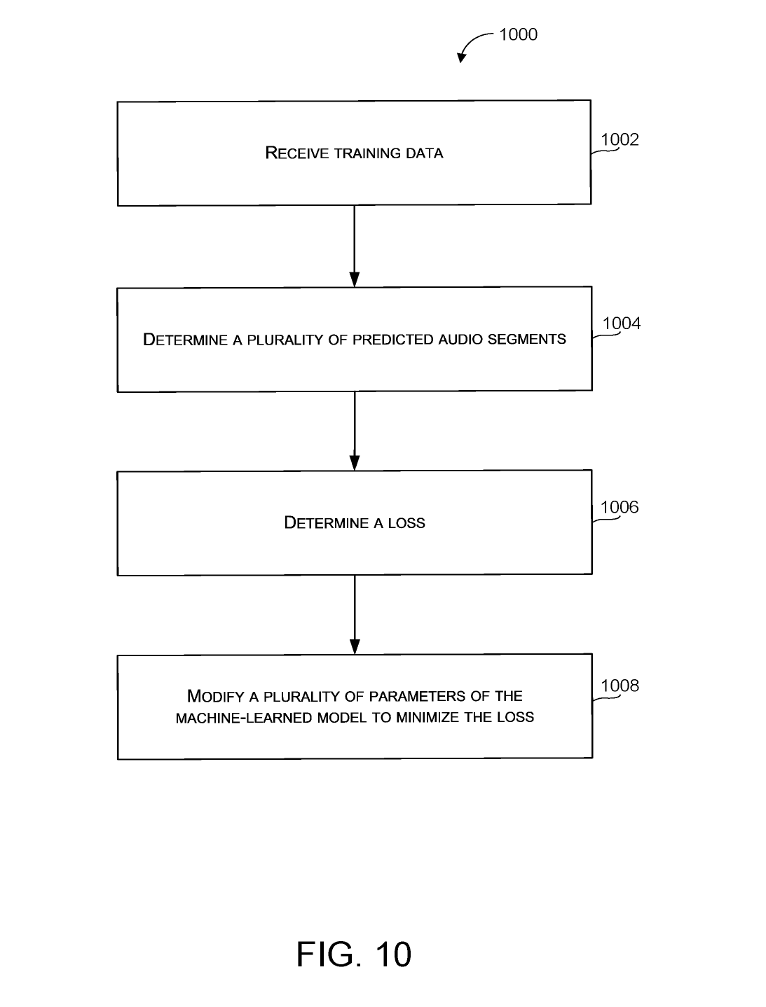

FIG. 10 depicts a flow chart diagram of an example method of training machine-learned models to generate context-based audio segments according to example embodiments of the present disclosure. One or more portions of the method 1000 can be executed and/or implemented on one or more computing devices or computing systems comprising, for example, the computing device 102, the server computing system 130, the training computing system 150, and/or the computing device 300. Further, one or more portions of the method 1000 can be executed or implemented as an algorithm on the hardware devices or systems disclosed herein. In some embodiments, one or more portions of the method 1000 can be performed as part of the method 800 that is described with respect to FIG. 8. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include receiving training data comprising a plurality of training data inputs and a corresponding plurality of ground-truth audio segments. For example, the server computing system 130 can receive training data comprising a plurality of training data inputs. The plurality of training data inputs can comprise a plurality of training images, a plurality of training audio segments, a plurality of training text segments, a plurality of training video segments, a plurality of training contexts, and/or a plurality of training prompts. For example, the plurality of training data inputs can comprise training images of various environments (e.g., desert landscapes, city skylines, mountain ranges, and/or lake views), a plurality of training contexts, and the plurality of ground-truth audio segments that can comprise music and/or sound effects that are relevant and/or suitable to the training images and/or the training contexts.

At 1004, the method 1000 can include determining, based on inputting the plurality of training data inputs into the machine-learned model, a plurality of predicted audio segments. For example, the server computing system 130 can implement a machine-learned model. Further, based on inputting the plurality of training data inputs into the machine-learned model, the one or more machine-learned models can perform one or more operations (e.g., detection, recognition, and/or classification operations) on the plurality of training data inputs and generate an output comprising a plurality of predicted audio segments.

At 1006, the method 1000 can include determining a loss based on one or more differences between the plurality of predicted audio segments and the plurality of ground-truth audio segments. For example, over a plurality of iterations, the server computing system 130 can determine a loss (e.g., a cross-entropy loss) based on one or more differences between the plurality of predicted audio segments and the plurality of ground-truth audio segments. The one or more differences between the plurality of predicted audio segments and the plurality of ground-truth audio segments can be based on one or more comparisons of the plurality of predicted audio segments to the plurality of ground-truth audio segments.

At 1008, the method 1000 can include modifying a plurality of parameters of the one or more machine-learned models to minimize the loss. For example, the server computing system 130 can modify a plurality of weights of the plurality of parameters so that the weights of the plurality of parameters that contribute to reducing the loss (e.g., the parameters that increase the accuracy of the one or more machine-learned models generating a plurality of predicted audio segments that are accurate) are increased and/or the weights of the plurality of parameters that contribute to increasing the loss (e.g., the parameters that decrease the accuracy of the one or more machine-learned models generating a plurality of predicted audio segments that are accurate) are decreased. The plurality of weights of the plurality of parameters can be modified until some threshold loss (e.g., a minimized loss) that corresponds to a high accuracy of the plurality of predicted audio segments is exceeded.

Further to the descriptions above, a user may be provided with controls allowing the user to make an election as to both if and/or when systems, programs, or features described herein may enable collection of user information (e.g., image information), and if the user is sent content or communications from a server. In addition, certain data may be treated in one or more ways before it is stored or used, so that certain information of a user may be removed. For example, a user’s identity may be treated so that certain other information associated with the user’s identity may not be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

The technology discussed herein makes reference to servers, databases, software applications, and other computer-based systems, as well as actions taken and information sent to and from such systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method of generating context-based audio content, the computer-implemented method comprising:
receiving, by a computing system comprising one or more processors, content data comprising content associated with one or more data multimodalities;
determining, by the computing system, one or more contexts associated with the content data;
determining, by the computing system, based on inputting the content data, the one or more prompts, and context data based on the one or more contexts into one or more machine-learned models, one or more context-based audio segments associated with the content data, wherein the one or more machine-learned models are configured to determine the one or more context-based audio segments based on recognition of one or more features of the content data and the context data; and
generating, by the computing system, context-based audio content based on the one or more context-based audio segments.

2. The computer-implemented method of claim 1, further comprising:
receiving, by the computing system, prompt data comprising one or more prompts associated with the content data, wherein the one or more machine-learned models are further configured to determine the one or more context-based audio segments based on recognition of one or more features of the one or more prompts.

3. The computer-implemented method of claim 1, wherein the determining, by the computing system, based on inputting the content data, the prompt data, and context data based on the one or more contexts into one or more machine-learned models, one or more context-based audio segments associated with the content data comprises:
selecting, by the computing system, the one or more context-based audio segments from a plurality of candidate audio segments.

4. The computer-implemented method of claim 1, wherein the one or more machine-learned models comprise one or more generative models that are configured to generate the one or more context-based audio segments, and wherein the determining, by the computing system, based on inputting the content data, the prompt data, and context data based on the one or more contexts into one or more machine-learned models, one or more context-based audio segments associated with the content data comprises:
generating, by the computing system, the one or more context-based audio segments based on recognition of the one or more features of the content data or the context data.

5. The computer-implemented method of claim 4, wherein a tempo of the one or more audio segments is based on the content data or the context data.

6. The computer-implemented method of claim 1, wherein the one or more context-based audio segments comprise one or more musical segments, one or more sound effects, or one or more conversation segments.

7. The computer-implemented method of claim 1, wherein the one or more machine-learned models are configured to determine one or more audio preferences of a user based on training data comprising a plurality of training audio segments of the user associated with the content data, and wherein the one or more machine-learned models are configured to determine the one or more context-based audio segments based on the one or more audio preferences.

8. The computer-implemented method of claim 1, wherein the one or more machine-learned models are configured to recognize one or more objects in the content data, and wherein the determining the one or more context-based audio segments is based on the recognition of the one or more objects.

9. The computer-implemented method of claim 1, further comprising:
generating, by the computing system, a link note comprising the context-based audio content and one or more links to one or more web resources associated with the context-based audio content, wherein the one or more web resources comprise one or more search results, one or more web pages, one or more database entries, or one or more social media posts.

10. The computer-implemented method of claim 1, wherein the one or more contexts comprise information associated with one or more locations, and wherein the one or more machine-learned models are configured to determine the one or more context-based audio segments based on the information associated with the one or more locations.

11. The computer-implemented method of claim 1, wherein the one or more contexts comprise one or more temporal indications associated with one or more times at which the content data was generated, wherein the one or more machine-learned models are configured to determine the one or more context-based audio segments based on the one or more temporal indications, wherein the one or more temporal indications comprise indications of a season or a time of day.

12. The computer-implemented method of claim 1, wherein the one or more contexts comprise information associated with one or more events associated with the content data, and wherein the one or more machine-learned models are configured to generate the one or more context-based audio segments based on the information associated with the one or more events.

13. The computer-implemented method of claim 1, wherein the content data comprises one or more images, one or more text segments, one or more audio segments, or one or more video segments.

14. The computer-implemented method of claim 1, wherein the one or more machine-learned models are trained to determine the one or more context-based audio segments, and wherein the training of the one or more machine-learned models comprises:
receiving, by the computing system, training data comprising a plurality of training data inputs and a corresponding plurality of ground-truth audio segments, wherein the plurality of training data inputs comprise a plurality of training images, a plurality of training audio segments, a plurality of training data inputs, a plurality of training text segments, or a plurality of training video segments;
determining, by the computing system, based on inputting the plurality of training data inputs into the one or more machine-learned models, a plurality of predicted audio segments;
determining, by the computing system, a loss based on one or more differences between the plurality of predicted audio segments and the corresponding plurality of ground-truth audio segments; and
modifying, by the computing system, a plurality of parameters of the one or more machine-learned models to minimize the loss.

15. The computer-implemented method of claim 1, wherein the one or more machine-learned models comprise one or more multimodal transformer models that are trained to determine the one or more context-based audio segments based on training data comprising a plurality of embeddings based on training data comprising training content data or training context data.

16. One or more tangible non-transitory computer-readable media storing computer-readable instructions that when executed by one or more processors cause the one or more processors to perform operations, the operations comprising:
receiving content data comprising content associated with one or more data multimodalities;
receiving one or more prompts associated with the content;
determining one or more contexts associated with the content data;
generating, based on inputting the content data, the one or more prompts, and context data based on the one or more contexts into one or more machine-learned models, one or more context-based audio segments associated with the content data, wherein the one or more machine-learned models are configured to generate the one or more context-based audio segments based on recognition of one or more features of the content data and the context data; and
generating context-based audio content based on the one or more context-based audio segments.

17. The one or more tangible non-transitory computer-readable media of claim 16, wherein the one or more machine-learned models are trained to determine one or more audio preferences based on training data comprising a plurality of training audio segments of a user associated with the content data, and wherein the one or more machine-learned models are configured to determine the one or more context-based audio segments based on the one or more audio preferences.

18. A computing system comprising:
one or more processors;
one or more non-transitory computer-readable media storing instructions that when executed by the one or more processors cause the one or more processors to perform operations comprising:
receiving content data comprising content associated with one or more data multimodalities;
receiving one or more prompts associated with the content;
determining one or more contexts associated with the content data;
generating, based on inputting the content data, the one or more prompts, and context data based on the one or more contexts into one or more machine-learned models, one or more context-based audio segments associated with the content data, wherein the one or more machine-learned models are configured to generate the one or more context-based audio segments based on recognition of one or more features of the content data and the context data; and
generating context-based audio content based on the one or more context-based audio segments.

19. The computing system of claim 18, wherein the one or more machine-learned models comprise one or more multimodal transformer models that are trained to determine the one or more context-based audio segments based on training data comprising a plurality of embeddings based on training data comprising training content data or training context data.

20. The computing system of claim 18, wherein the one or more machine-learned models are trained to determine one or more audio preferences based on training data comprising a plurality of training audio segments of a user associated with the content data, and wherein the one or more machine-learned models are configured to determine the one or more context-based audio segments based on the one or more audio preferences.
